(19) United States
(12) Patent Application Publication
(10) Pub. No.: US 2016/0103366 A1
(43) Pub. Date: Apr. 14, 2016

(54) BACKLIGHT STRUCTURE AND LIQUID CRYSTAL DISPLAY DEVICE

(71) Applicant: Shenzhen China Star Optoelectronics Technology Co. Ltd., Shenzhen, Guangdong (CN)

(72) Inventors: Shihhsiang CHEN, Shenzhen, Guangdong (CN); Yuchun HSIAO, Shenzhen, Guangdong (CN); Dehua LI, Shenzhen, Guangdong (CN)

(73) Assignee: Shenzhen China Star Optoelectronics Technology Co. Ltd., Shenzhen, Guangdong (CN)

(21) Appl. No.: 14/399,943

(22) PCT Filed: Oct. 13, 2014
(86) PCT No.: PCT/CN2014/088516

§ 371 Date: Nov. 7, 2014

(30) Foreign Application Priority Data
Oct. 9, 2014 (CN) 201410529274.X

(51) Int. Cl. G02F 1/1335

(52) U.S. Cl. CPC G02F 1/133608; G02F 1/133603

(57) ABSTRACT

A backlight structure comprises a back plate which light emitting bodies are disposed on the back plate, and a bump structure is disposed on the back plate. The light emitting bodies are disposed on the bump structure. The bump structure can be protruding bars, or cylindrical ring stands having the same concentric point. Also, a liquid crystal display device which the backlight structure used in is disclosed. The backlight structure changes some parameters, such as the light emitting angle of the lamps and the light density, by fixing the light emitting bodies of the backlight structure on the curved back plate, so that it is conductive to uniform the light source, enhance the efficiency of the mixed light and reduce the thickness of the direct type back light structure.

### FIELD OF THE INVENTION

The present invention relates to a backlight structure and a liquid crystal display panel on a direct type liquid crystal display device.

### BACKGROUND OF THE INVENTION

The traditional direct type liquid crystal display device is that the light from an light emitting array arranged on the back plane of the liquid crystal display panel emits into the diffusion plate, goes through the optical films evenly, and form back light source for liquid crystal glasses. The light emitting body of the direct type structure needs a certain distance to radiate, so it should be occupied a certain thickness or it should enhance the light uniformity via increasing the density of light emitting array. However, it makes the module be very thick or the cost of the light emitting array be increased.

### SUMMARY OF THE INVENTION

In order to solve the problem existing in the traditional art, one of the invention goals is to provide a backlight structure.

In order to achieve the goal of the invention mentioned above, the invention uses the backlight structure, comprising a back plate and light emitting bodies on the back plate, wherein a bump structure and the light emitting bodies disposed on the bump structure.

Further, the bump structure is a camber that the back plate protrudes inwards.

Further, the bump structure is a plurality of inward protruding bars, arranged in parallel on the back plate.

Further, the inward protruding bars are disposed in the direction of the width of the back plate, and an outer surface of the inward protruding bars is a curve surface of which the two ends are low but the middle part is high.

Further, the bump structure is a plurality of cylindrical ring stands which the back plate protruding inwards, and a stand plane of the cylindrical ring stands is inclined.

Further, the center of the cylindrical ring stands is the center of the back plate.

Further, the plurality of cylindrical ring stands are the two cylindrical ring stands, comprising an inward cylindrical ring stand and an outward cylindrical ring, wherein a stand plane of the inward cylindrical ring stand is an inclined plane inclining from inside to outside, and a stand plane of the outward cylindrical ring stand is an inclined plane inclining from outside to inside.

Further, the light emitting body is disposed on the bump structure evenly.

Further, the light emitting bodies are LED light bars.

The other goal of the present invention is to provide a liquid crystal display device, comprising a backlight structure, wherein the backlight structure comprises a back plate, and light emitting bodies are disposed on the back plate, wherein a bump structure disposed on the back plate and the light emitting bodies are disposed on the bump structure.

Further, the bump structure is a camber that the back plate protrudes inwards.

Further, the bump structure is a plurality of inward protruding bars, arranged in parallel on the back plate, and the inward protruding bars are disposed in direction of width of the back plate, and an outer surface of the inward protruding bars is a curve surface of which the two ends are low but the middle part is high.

Further, the bump structure is a plurality of cylindrical ring stands which the back plate protrudes inwards, and a stand plane of the cylindrical ring stands is inclined.

Further, the center of the cylindrical ring stands is the center of the back plate, and the plurality of cylindrical ring stands are the two cylindrical ring stands, comprising an inward cylindrical ring stand and an outward cylindrical ring, wherein a stand plane of the inward cylindrical ring stand is an inclined plane inclining from inside to outside, and a stand plane of the outward cylindrical ring stand is an inclined plane inclining from outside to inside.

Further, the center of the cylindrical ring stands is the center of the back plate, and the plurality of cylindrical ring stands are the two cylindrical ring stands, comprising an inward cylindrical ring stand and an outward cylindrical ring, wherein a stand plane of the inward cylindrical ring stand is an inclined plane inclining from inside to outside, and a stand plane of the outward cylindrical ring stand is an inclined plane inclining from outside to inside.

### BRIEF DESCRIPTION OF THE DRAWINGS

FIG. 1 is a sectional diagram of the backlight structure of the first embodiment of the present invention.

FIG. 2 is a schematic diagram of the back plate of the second embodiment of the present invention.

FIG. 3 is a schematic diagram of the backlight structure of the second embodiment of the present invention.

FIG. 4 is an exploded view of the liquid crystal display device of the second embodiment of the present invention.

FIG. 5 is a schematic diagram of the back plate of the third embodiment of the present invention.

FIG. 6 is a schematic diagram of the backlight structure of the third embodiment of the present invention.

FIG. 7 is a sectional diagram of the backlight structure of the third embodiment of the present invention.

FIG. 8 is an enlarged schematic diagram of A portion in FIG. 7.

### DETAILED DESCRIPTION OF THE PREFERRED EMBODIMENTS

In order to elaborate the technical characteristics and the structure of the present invention well, the following examples combining with the accompanying drawings in detail.

### First Embodiment

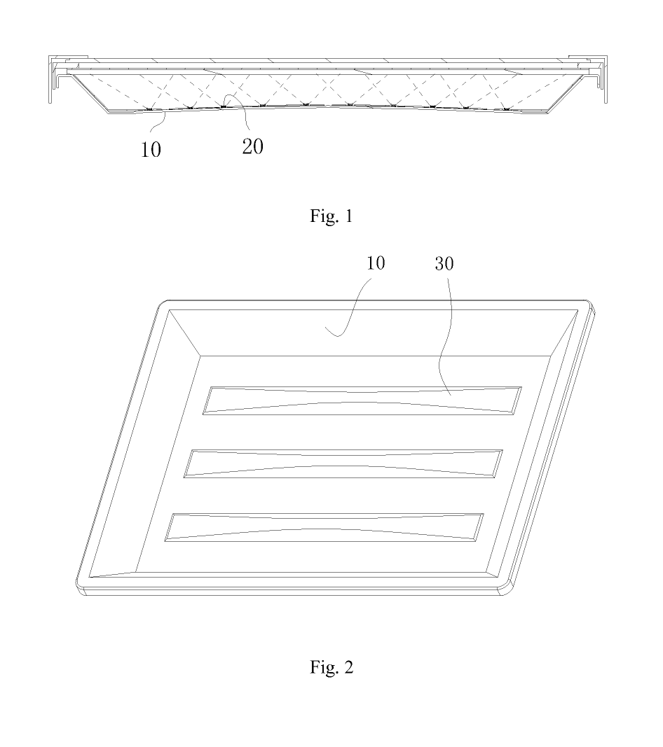

As shown in FIG. 1, the first embodiment discloses a backlight structure, which comprises a back plate 10 and the back plate has different design comparing with the traditional flat back plate. The back plate has a bump structure which is a curved protrusion or called a camber which the back plate protruding inwards. According to the size of the back plate, the direction of the long side is the width direction; correspondingly, the direction of the short side is the height direction. The first embodiment requires that the bump structure of the camber is the structure protruding gradually inwards from the two sides to the middle part along the width direction, i.e. the bump structure in the certain axis of the width direction has the same height in the height direction. The light emitting bodies are disposed evenly on the back plate 10. The light emitting bodies of the first embodiment could be LED light bars 20. The backlight structure of the first embodiment enables the projecting direction of the LED light bars on the camber to be radial and to enlarge the projecting angle. The LED lamps on the LED light bar should be arranged as much evenly as possible to achieve the uniformity of the emitting light. In the bump structure of the back plate 10, essentially the LED lamps should be arranged based on the angle change of the bump structure, which the advantage is to modulate the light uniformity and enhance the efficiency of the mixing light. Moreover, the thickness of the direct type backlight structure can be further reduced. In light of the design of the bump structure of the back plate 10, the amount and position of the LED light bars 20 can be modulated based on the density and power of the LED lamp array.

Where, in Step S101, a color analyzer could be employed to measuring the three tristimulus values X, Y, Z of the image.

### Second Embodiment

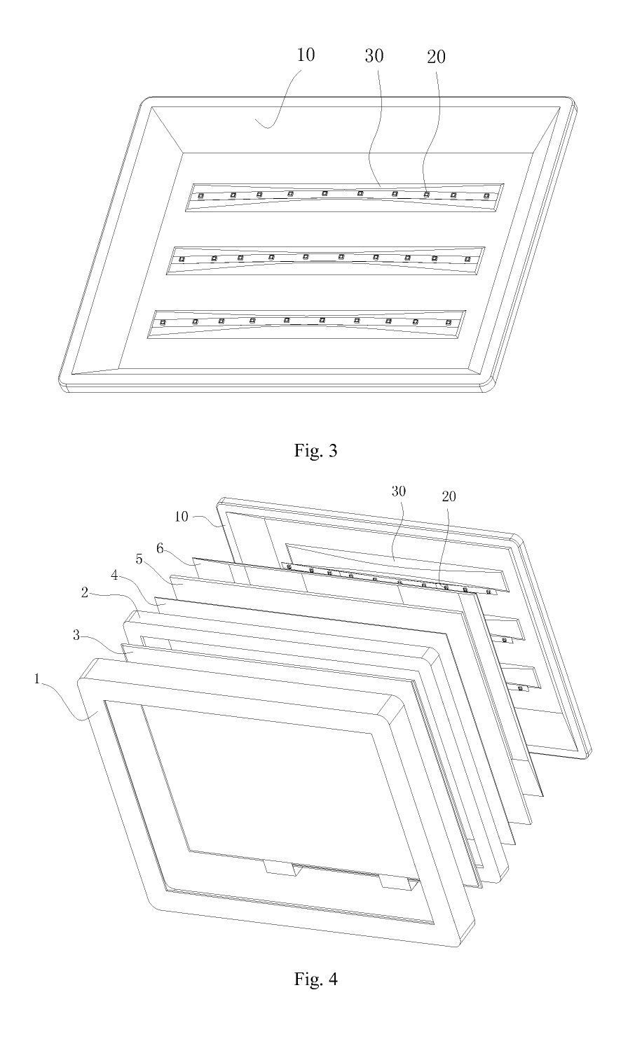

As shown in FIG. 2, a bump structure of a back plate 10 is inward protruding bars 30 arranged in a certain rule designed in advance. The inward protruding bars 30 are disposed in the width direction of the back plate 10, and the outer surfaces of the inward protruding bars are curve surfaces of which the two ends are low but the middle part is high. LED light bars 20 are pasted on the camber of the inward protruding bars 30, as shown in FIG. 3. Then, refer to FIG. 4, and the direct type liquid crystal display device comprises a front plate 1, a plastic plate 2, a LCD glass 3, an optical film 4, a light guide plate 5, a back plate 10, light bars 20 and a reflection plate 6. The backlight structure of the liquid crystal display device is used for reducing the thickness of the back light structure.

### Third Embodiment

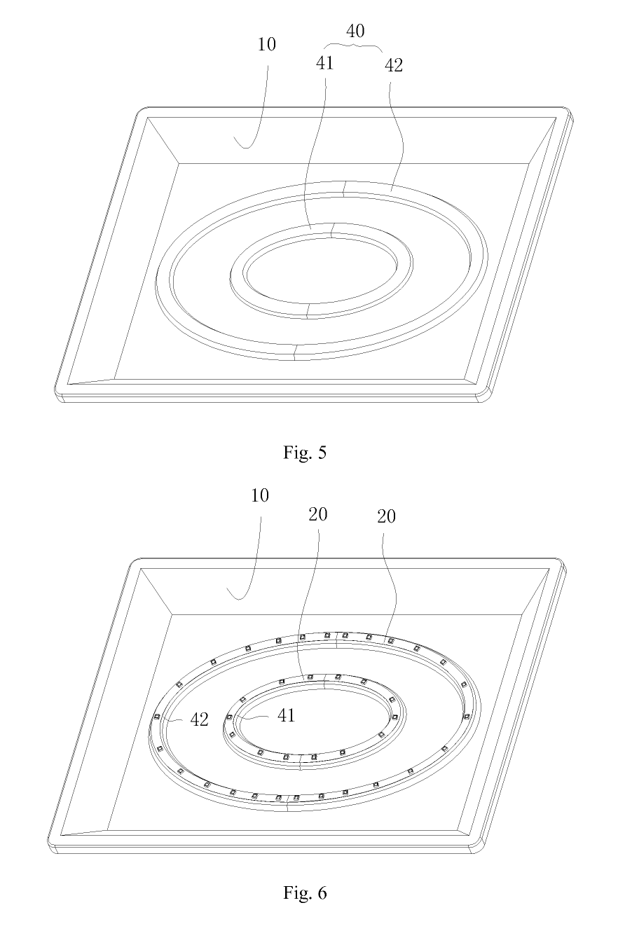

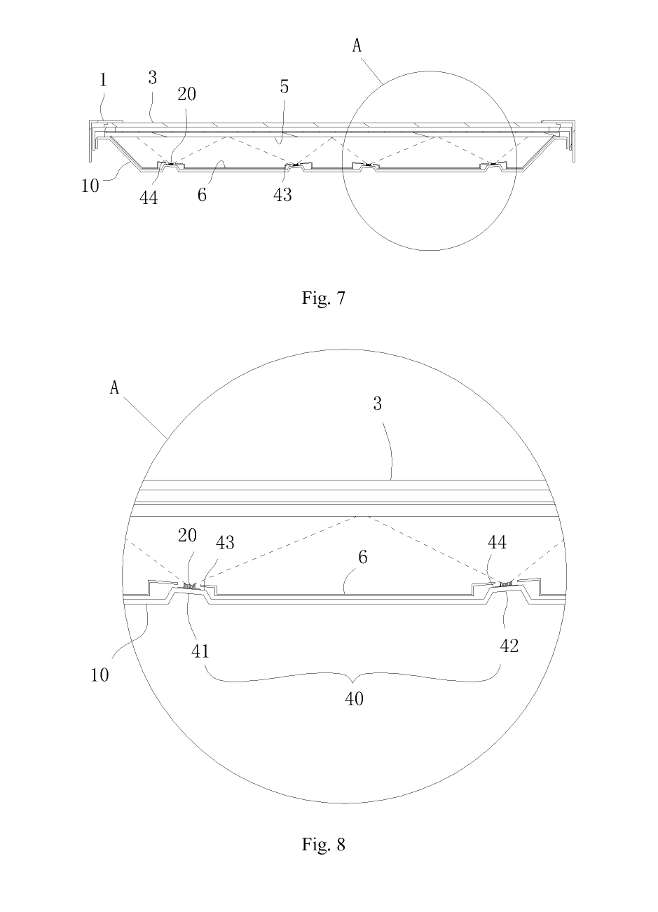

Please refer to FIG. 5 to FIG. 8. The difference of the third embodiment comparing with the other embodiments is: the bump structure is a plurality of cylindrical ring stands 40 which the back plate protrudes inwards. Pertaining to the third embodiment, there are two cylindrical ring stands 40 comprising inward cylindrical ring stands 41 and outward cylindrical rings 42. In order to make the light be more even, the center of the cylindrical ring stands is positioned in the center of the back plate 10. Otherwise, for the purpose of the LED light bars 20 having the deformation with the certain angle change, the stand planes of the cylindrical ring stands 40 comprises inclined planes, which one stand plane of the inward cylindrical ring stand inclines from inside to outside and the other stand plane of the outward cylindrical ring stand inclines from outside to inside. In this way, the LED light bars 20 are also rings pasted on the stand planes. It can be understood that the shape of the reflection plate 6 is same as one of the back plate when the embodiment applies in liquid crystal display device. The reflection plate 6 has deformation where the cylindrical ring stand 40 is. Also, holes need to be disposed in the place corresponding to the LED light bars. The structure of the third embodiment can achieve the same result as the other embodiments.

The above-described preferred embodiment of the present invention, it is not intended to limit the present invention, any modification within the spirit and principles of the present invention made of such equivalent alterations and modifications should be included in the present within the scope of the invention.

What is claimed is:

1. A backlight structure, comprising a back plate and light emitting bodies on the back plate, wherein a bump structure and the light emitting bodies disposed on the bump structure.

2. The backlight structure as claimed in claim 1, wherein the bump structure is a camber that the back plate protrudes inwards.

3. The backlight structure as claimed in claim 1, wherein the bump structure is a plurality of inward protruding bars, arranged in parallel on the back plate.

4. The backlight structure as claimed in claim 3, wherein the inward protruding bars are disposed in direction of width of the back plate, and an outer surface of the inward protruding bars is a curve surface of which two ends are low but middle part is high.

5. The backlight structure as claimed in claim 1, wherein the bump structure is a plurality of cylindrical ring stands which the back plate protruding inwards, and a stand plane of the cylindrical ring stands is inclined.

6. The backlight structure as claimed in claim 5, wherein center of the cylindrical ring stands is center of the back plate.

7. The backlight structure as claimed in claim 5, wherein the plurality of cylindrical ring stands are the two cylindrical ring stands, comprising an inward cylindrical ring stand and an outward cylindrical ring, wherein a stand plane of the inward cylindrical ring stand is an inclined plane inclining from inside to outside, and a stand plane of the outward cylindrical ring stand is an inclined plane inclining from outside to inside.

8. The backlight structure as claimed in claim 1, wherein the light emitting body is disposed on the bump structure evenly.

9. The backlight structure as claimed in claim 2, wherein the light emitting bodies are disposed on the bump structure evenly, and the light emitting bodies are LED light bars.

10. The backlight structure as claimed in claim 3, wherein the light emitting bodies are disposed on the bump structure evenly, and he light emitting bodies are LED light bars.

11. The backlight structure as claimed in claim 4, wherein the light emitting bodies are disposed on the bump structure evenly, and he light emitting bodies are LED light bars.

12. The backlight structure as claimed in claim 5, wherein the light emitting bodies are disposed on the bump structure evenly, and the light emitting bodies are LED light bars.

13. The backlight structure as claimed in claim 6, wherein the light emitting bodies are disposed on the bump structure evenly, and he light emitting bodies are LED light bars.

14. The backlight structure as claimed in claim 7, wherein the light emitting bodies are disposed on the bump structure evenly, and he light emitting bodies are LED light bars.

15. The backlight structure as claimed in claim 7, wherein the light emitting bodies are LED light bars.

16. A liquid crystal display device, comprising a backlight structure, wherein the backlight structure comprises a back plate, and light emitting bodies are disposed on the back plate, wherein a bump structure disposed on the back plate and the light emitting bodies are disposed on the bump structure.

17. The liquid crystal display device as claimed in claim 16, wherein the bump structure is a camber that the back plate protrudes inwards.

18. The liquid crystal display device as claimed in claim 16, wherein the bump structure is a plurality of inward protruding bars, arranged in parallel on the back plate, and the inward protruding bars are disposed in direction of width of the back plate, and an outer surface of the inward protruding bars is a curve surface of which two ends are low but middle part is high.

19. The liquid crystal display device as claimed in claim 16, wherein the bump structure is a plurality of cylindrical ring stands which the back plate protrudes inwards, and a stand plane of the cylindrical ring stands is inclined.

20. The liquid crystal display device as claimed in claim 19, wherein center of the cylindrical ring stands is center of the back plate, and the plurality of cylindrical ring stands are the two cylindrical ring stands, comprising an inward cylindrical ring stand and an outward cylindrical ring, wherein a stand plane of the inward cylindrical ring stand is an inclined plane inclining from inside to outside, and a stand plane of the outward cylindrical ring stand is an inclined plane inclining from outside to inside.
